(19) United States
(12) Patent Application Publication
(10) Pub. No.: US 2007/0269261 A1
(43) Pub. Date: Nov. 22, 2007

(54) DIVIDER FOR A DOCUMENT STORAGE DEVICE

(75) Inventor: Mark C. Sapienza, Wheaton, IL (US)

Correspondence Address: MICHAEL BEST & FRIEDRICH LLP, 100 EAST WISCONSIN AVENUE, SUITE 3300, MILWAUKEE, WI, 53202, US

(73) Assignee: ACCO Brands USA LLC, Lincolnshire, IL (US)

(21) Appl. No.: 11/381,413

(22) Filed: May 3, 2006

(51) Int. Cl. B42F 13/00

(52) U.S. Cl. 402/79

(57) ABSTRACT

A divider configured to separate a plurality of sheets in a document storage device. The divider includes a body portion configured to be placed between the plurality of sheets in the document storage device. A tab portion extends from the body portion, and the tab portion is configured to extend beyond an edge of the plurality of sheets. A sheet receiving feature is generally aligned with the tab portion and positioned on at least one of the body portion and the tab portion. The sheet receiving feature is operable to receive a portion of one of the plurality of sheets to couple the sheet to the divider.

### BACKGROUND

The present invention relates to a document storage device, and more particularly to a divider configured to separate a plurality of sheets retained within the document storage device.

Document storage devices, such as ring binders, spiral binders, books or folders, commonly include a plurality of sheets and dividers configured to separate the sheets. The dividers typically include a tab that extends beyond the sheets so that certain sheets can be easily located. The tabs can be labeled to identify the portions of the sheets separated by the dividers.

### SUMMARY

The above-described dividers are helpful in finding a specific sheet or location in a plurality of sheets. In order to change the desired sheet or location to be found, the divider must be moved to a different position in the plurality of sheets.

The invention provides a divider configured to separate a plurality of sheets in a document storage device. The divider includes a body portion configured to be placed between the sheets in the document storage device. A tab portion extends from the body portion, beyond an edge of the body portion. The divider also includes a sheet receiving feature positioned generally along the edge of the body portion, on at least one of the body portion and the tab portion. The sheet receiving feature is operable to receive a portion of one of the sheets to couple the sheet to the divider.

In another embodiment the invention provides a document storage device that includes a cover, a plurality of sheets retained within the cover, and a divider configured to separate the plurality of sheets. The divider includes a body portion configured to be placed between the sheets in the document storage device. A tab portion extends from the body portion, beyond and edge of the body portion. The divider also includes a sheet receiving feature positioned generally along the edge of the body portion, on at least one of the body portion and the tab portion. The sheet receiving feature is operable to receive a portion of one of the sheets to couple the sheet to the divider.

Other aspects of the invention will become apparent by consideration of the detailed description and accompanying drawings.

### BRIEF DESCRIPTION OF THE DRAWINGS

FIG. 1 is a perspective view of a document storage device including a plurality of dividers embodying the invention.

FIG. 2 is a plan view of one of the dividers of FIG. 1.

FIG. 3 is an enlarged plan view of a portion of the divider of FIG. 2.

FIG. 4 is a perspective view of a first mode of operating the divider of FIG. 2.

FIG. 5 is a perspective view of a second mode of operating the divider of FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

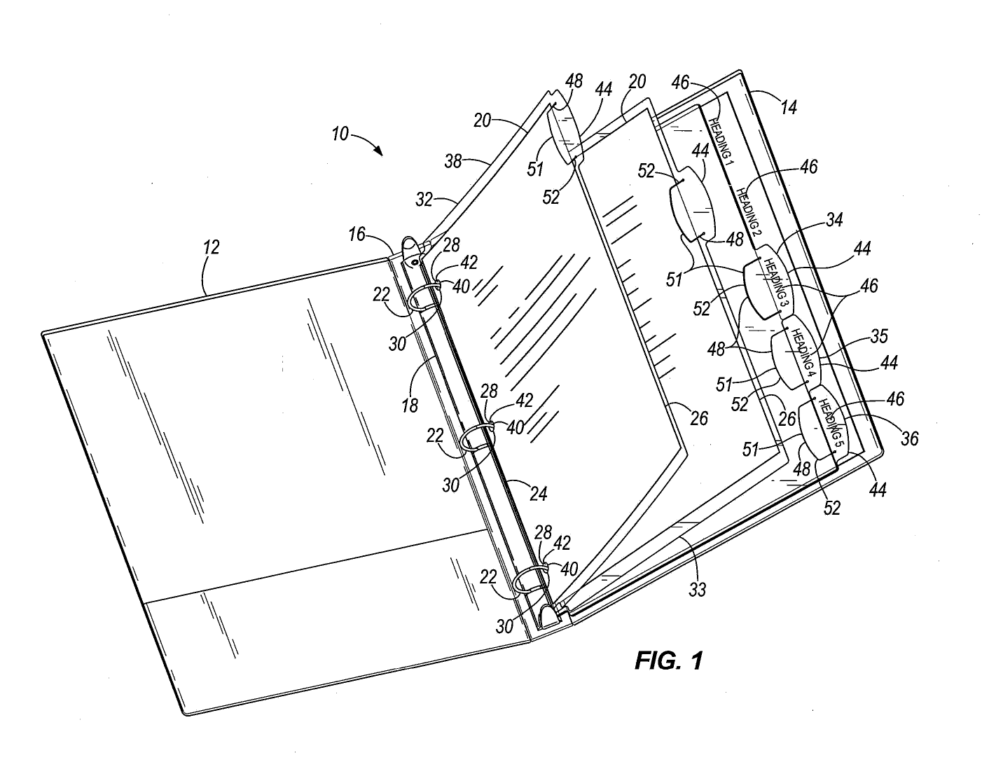

FIG. 1 illustrates a document storage device 10 that includes a front cover 12, a back cover 14 and a spine 16 that connects the front cover 12 and the back cover 14. A binding mechanism 18 is attached to the spine 16 for retaining a plurality of sheets 20 between the front cover 12 and the back cover 14. While the illustrated binding mechanism 18 is a three ring binder including rings 22, it should be understood that the binding mechanism 18 may omit the rings 22 and may include other features, such as spirals, clamps, clasps, hooks, glue, staples or other ring type features. The illustrated binding mechanism 18 is operable, such that the plurality of sheets 20 can be removed from the document storage device 10. However, other types of binding mechanism, such as spirals or glue, that may not be operable to release the plurality of sheets 20 can also be utilized. Additionally, the document storage device 10 can take other forms such as files, envelopes, books, magazines and the like, which are used to store documents.

Each of the plurality of sheets 20 includes a first edge 24 and a second edge 26. A binding feature 28 is located adjacent the first edge 24 and is configured to couple each of the plurality of sheets to the binding mechanism 18. The illustrated binding feature 28 includes three holes 30 punched through each of the plurality of sheets 20. Each of the holes 30 is configured to receive one of the rings 22 of the binding mechanism 18. In other constructions, the plurality of sheets 20 can be coupled to the binding mechanism using other suitable binding features. For example, the plurality of sheets 20 can include any number and shape of holes or apertures that are configured to receive spirals, clamps, hooks, and the like. In other constructions, the plurality of sheets may not include holes or apertures and may be glued or stapled to the spine 16.

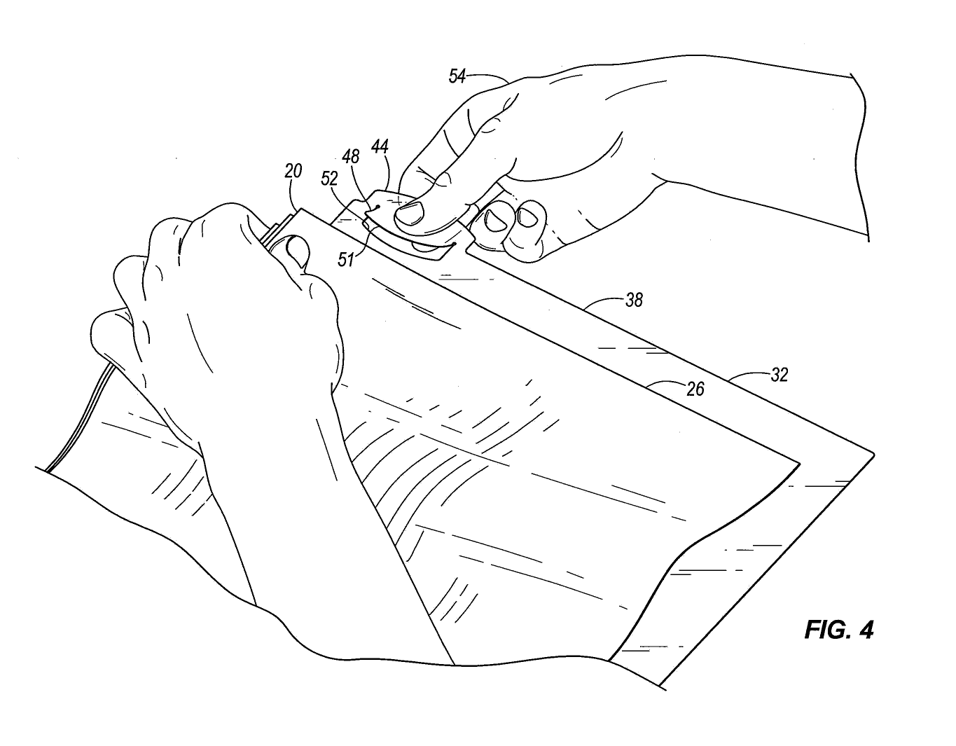

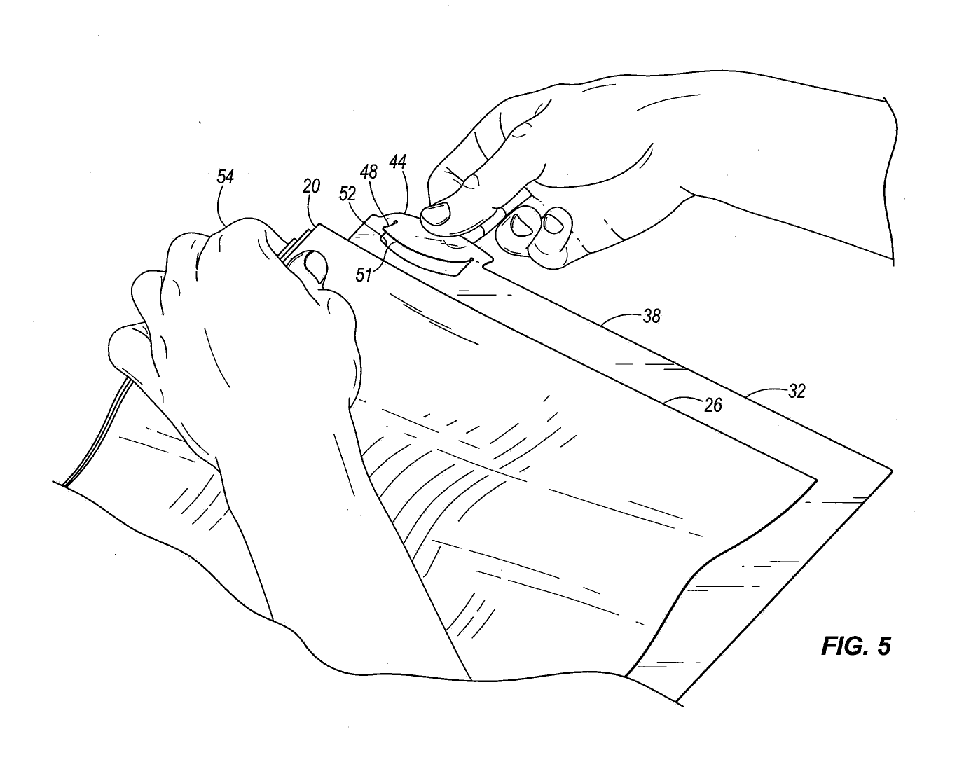

The illustrated plurality of sheets 20 are standard 8½×11 inch sheets. In other constructions, the plurality of sheets 20 can be any suitable size, such as A4 size, which measures 8.264×11.684 inches, or legal size, which measures 8½×14 inches. In yet other constructions, the plurality of sheets 20 can be sized for use in a personal planner, such sheets may measure 6×8 inches, 5½×8 inches or 3×5 inches. It should be understood that in such alternative constructions the size of the front cover 12, the back cover 14, and the spine 16 can be sized to correspond with the size of the plurality of sheets 20. In addition, while the document storage device 10 shown in FIG. 1 includes the two sheets 20 for clarity, it should be understood that the document storage device 10 may include more than the two sheets 20 (see FIGS. 4 and 5).

With continued reference to FIG. 1, five dividers 32-36 are configured to separate the plurality of sheets 20 that are retained within the document storage device 10. While the illustrated document storage device 10 includes five dividers 32-36, it should be understood that the document storage device 10 can include more than five, or less than five dividers. Furthermore, any suitable number of sheets 20 can be located between each of the dividers 32-36. For illustrative purposes only one sheet 20 is shown between the dividers 32 and 33 and no sheets are shown between the other dividers 33-36. In other embodiments, several sheets can be located between dividers 32-36. Also, while one sheet 20 is located between the divider 32 and the front cover 12, it should be understood that in other constructions, several sheets can be located between the divider 32 and the front cover 12. In yet other constructions, there may not be any sheets between the front cover 12 and the divider 32, and there may be sheets located between the divider 36 and the back cover 14.

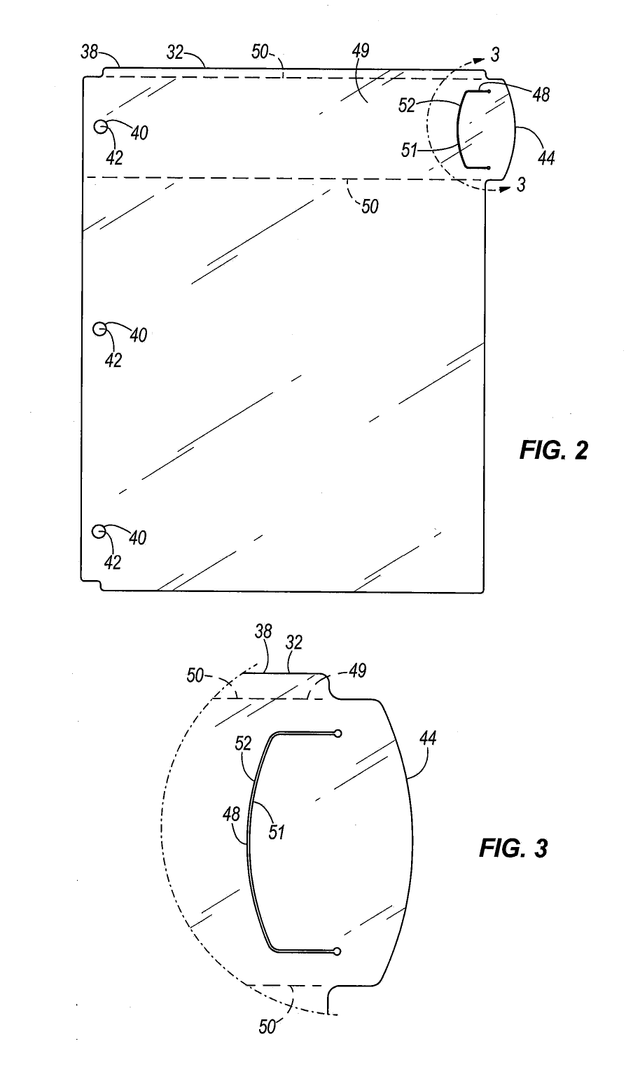

Each of the dividers 32-36 is substantially similar, and thus only one divider 32 will be described in detail. Referring to FIGS. 1 and 2, the divider 32 includes a translucent body 38 that is configured to be placed between the plurality of sheets 20. While the illustrated body 38 is translucent, in other constructions, the body 38 can be opaque. The body 38 of the divider 32 has generally about the same dimensions as the plurality of sheets 20. For example, in the illustrated construction, the plurality of sheets 20 are standard 8½×11 inch sheets and the body 38 extends slightly beyond the plurality of sheets 20. In other constructions, the body 38 may extend even farther beyond the plurality of sheets 20, and in yet other constructions, the body 38 may not extend beyond the plurality of sheets 20. Furthermore, it should be understood that the body 38 of the divider 32 can be any suitable size, such as A4 size, legal size, or other sizes, such as 6×8 inches, 5½8 inches or 3×5 inches.

The divider 32 also includes a binding feature 40 configured to couple the divider 32 to the binding mechanism 18. The illustrated binding feature 40 includes three holes 42 configured to receive the rings 22 of the binding mechanism 18. In other constructions, the binding feature 40 can include any suitable number of holes or apertures of any shape or size that are configured to receive spirals, clamps, clasps, hooks, and the like. In yet other constructions, glue can be utilized to couple the divider 32 to the spine 16.

A tab 44 extends from an edge of the body 38. When the body 38 and the plurality of sheets 20 are retained within the document storage device 10, the tab 44 extends beyond an edge of the sheets 20. While the illustrated tab 44 extends beyond the second edge 26 of the sheets 20, in other constructions, the tab 44 can extend beyond other edges of the sheets 20.

The illustrated tab 44 is integrally formed with the body 38. In other constructions however, the tab 44 can be a separate member that is coupled to the body 38.

Referring to FIG. 1, the tab 44 can be located at different locations on the body 38. For example, the illustrated divider 32 includes the tab 44 at a first location, and the divider 33 includes the tab 44 at a second location, such that the tabs 44 of the dividers 33 and 34 do not substantially cover or overlap each other when the dividers 32, 34 are coupled to the spine 16. The tab 44 of the dividers 34, 35, and 36 are similarly placed such that the tabs 44 do not substantially cover or overlap each other when the dividers 32-36 are coupled to the spine 16.

The illustrated tab 44 is translucent, such that an indicia 46 is visible through the tab 44. The indicia 46 can be any suitable indicia that identifies the plurality of sheets 20 located adjacent the divider 32. Examples of document storage devices that utilize such an arrangement of dividers and indicia are shown in U.S. Pat. No. 6,511,246, the entire contents of which are incorporated herein by reference. In other constructions, the indicia 46 can be located directly on the tab 44. The indicia need not take the form of alphanumeric symbols, but can also take the form of different colored or shaped tabs 44

Referring to FIGS. 2 and 3, a sheet receiving feature 48 is positioned generally along the same edge of the body portion 38 from which the tab 44 extends, and in the illustrated embodiment is generally aligned with the tab 44. A tab zone 49 is defined generally by the area between lines 50 that extend from ends of the tab 44 into the body 38. The illustrated sheet receiving feature 48 is located within the tab zone 50. This facilitates use and manipulation of the sheet receiving feature 48 by the user via the tab 44. Furthermore, the added material of the tab 44 enables placement of the sheet receiving feature 48 closer to the edge 26 than may be otherwise possible if the sheet receiving feature were not generally aligned with the tab 44. In other constructions, the sheet receiving feature 48 may not be located within the tab zone 50, or may be only partially located within in the tab zone 50 Furthermore, more than one sheet receiving feature 48 can be present on each divider 32.

The illustrated sheet receiving feature 48 includes a flap 51 formed by a slit 52 in at least one of the body 38 and the tab 44. While the illustrated slit 52 is located through both the tab 44 and the body 38, in other constructions, the slit 52 may be through only the body 38. In yet other constructions, the slit 52 may be located through only the tab 44. The flap 51 formed by the slit 52 is only one possible construction of the sheet receiving feature 48. In other constructions, the sheet receiving feature 48 may omit the slit 52 and can include a flap, a lip, or other suitable structure coupled to or integrally formed with at least one of the body 38 and tab 44.

Referring to FIG. 4, in operation, a user 54 selects a sheet retained within the document storage device that is to be marked. Then, the user couples at least one sheet 20 to the divider 32 in order to mark the desired sheet. To couple the sheets 20 to the divider, the user 54 deflects the flap 51 out of the plane defined by the body 38 and inserts the second edge 26 of the sheets 20 between the flap 51 and the body 38. Then the user 54 releases the flap 51 and the sheets 20 are coupled to the divider 32, marking the desired sheet (FIG. 1).

Referring to FIG. 5, in another mode of operation the user 54 can deflect the tab 44, such that the flap 51 is forced to deflect out of the plane defined by the body 38. The second edge 26 of the sheets 20 can then be inserted between the flap 51 and the body 38 to couple the sheets 20 to the divider 32.

While the illustrated flap 51 is deflected towards the user 54, it should be understood that the flap 51 can be deflected in the opposite direction, away from the user 54. The flap 51 can be deflected away from the user 54 to couple sheets to the divider 32 that are located behind the divider 32.

Referring to FIG. 1, with the desired sheet marked, the user 54 can then close the front and back covers 12, 14 of the document storage device 10, and the next time the user desires to use the document storage device 10, he or she can select the tab 44 and open the document storage device 10 to the sheet that was marked.

FIG. 1 illustrates the sheets 20 coupled to the dividers 32, 33. For illustrative purposes only one sheet 20 is shown coupled to the dividers 32 and 33 and there are no sheets coupled to the dividers 34, 35 and 36. However, it should be understood that more than one sheet 20 can be located between the dividers 32-36 and the sheet receiving feature 48 can couple more than one sheet 20 to the dividers 32-36.

Thus, the invention provides, among other things, a divider 32 that includes a sheet receiving feature 48 operable to couple a sheet 20 to the divider 32. Various features and advantages of the invention are set forth in the following claims.

What is claimed is:

1. A divider configured to separate a plurality of sheets in a document storage device, the divider comprising:
a body portion configured to be placed between the plurality of sheets in the document storage device;
a tab portion extending from the body portion beyond an edge of the body portion; and
a sheet receiving feature positioned generally along the edge of the body portion, on at least one of the body portion and the tab portion, and operable to receive a portion of at least one of the plurality of sheets to couple the sheet to the divider.

2. The divider of claim 1, wherein the sheet receiving feature is generally aligned with the tab portion.

3. The divider of claim 2, wherein the tab portion defines a tab zone extending from the tab portion into the body portion and having a width substantially the same as a width of the tab portion, and wherein the sheet receiving feature is at least partially positioned in the tab zone.

4. The divider of claim 1, wherein the sheet receiving feature includes a flap operable to receive a portion of at least one of the sheets.

5. The divider of claim 4, wherein the flap is integrally formed with at least one of the body portion and the tab portion.

6. The divider of claim 4, wherein the flap is formed by a slit in at least one of the body portion and the tab portion.

7. The divider of claim 6, wherein the slit is in both the body portion and the tab portion.

8. The divider of claim 4, wherein the body portion defines a plane, and wherein the flap is deflectable out of the plane for receiving the portion of the sheet.

9. The divider of claim 8, wherein the flap is deflectable by deflecting the tab portion.

10. The divider of claim 1, wherein the tab portion is translucent.

11. A document storage device comprising:
a cover;
a plurality of sheets retained within the cover; and
a divider configured to separate the plurality of sheets, the divider including,
a body portion configured to be placed between the plurality of sheets in the document storage device;
a tab portion extending from the body portion beyond an edge of the body portion; and
a sheet receiving feature positioned generally along the edge of the body portion, on at least one of the body portion and the tab portion, and operable to receive a portion of at least one of the plurality of sheets to couple the sheet to the divider.

12. The document storage device of claim 11, wherein the sheet receiving feature is generally aligned with the tab portion.

13. The document storage device of claim 12, wherein the tab portion defines a tab zone extending from the tab portion into the body portion and having a width substantially the same as a width of the tab portion, and wherein the sheet receiving feature is at least partially positioned in the tab zone.

14. The document storage device of claim 11, wherein the sheet receiving feature includes a flap operable to receive a portion of at least one of the sheets.

15. The document storage device of claim 14, wherein the flap is integrally formed with at least one of the body portion and the tab portion.

16. The document storage device of claim 14, wherein the flap is formed by a slit in at least one of the body portion and the tab portion.

17. The document storage device of claim 16, wherein the slit is in both the body portion and the tab portion.

18. The document storage device of claim 14, wherein the body portion defines a plane, and wherein the flap is deflectable out of the plane for receiving the portion of the sheet.

19. The document storage device of claim 18, wherein the flap is deflectable by deflecting the tab portion.

20. The document storage device of claim 11, wherein the tab portion is translucent.

21. The document storage device of claim 11, wherein the divider is a first divider, and the document storage device further comprises a second divider substantially similar to the first divider except for the position of the tab portion with respect to the plurality of sheets.
